(19) United States
(12) Patent Application Publication
(10) Pub. No.: US 2014/0082221 A1
(43) Pub. Date: Mar. 20, 2014

(54) INTERFACE ADAPTER AND INTERFACE ADAPTING METHOD THEREOF

(71) Applicant: REALTEK SEMICONDUCTOR CORPORATION, HSINCHU (TW)

(72) Inventors: Yun Peng KAO, Zhubei City (TW); Chun-Wei CHEN, Hsinchu City (TW)

(73) Assignee: REALTEK SEMICONDUCTOR CORPORATION, HSINCHU (TW)

(21) Appl. No.: 14/025,458

(22) Filed: Sep. 12, 2013

(30) Foreign Application Priority Data
Sep. 14, 2012 (TW) 101133876

(51) Int. Cl. H04L 12/24

(52) U.S. Cl. CPC H04L 41/04
USPC 709/250

(57) ABSTRACT

An interface adapter and an interface adapting method thereof are provided. The interface adapter includes a body, a network interface and a card interface. The network interface is disposed on the body, and is configured to connect with a wired network for receiving a network signal from the wired network. The card interface is disposed on the body and connects with the network interface electrically, and is configured to connect with a card slot of a host, and to transmit the network signal to the host via the card slot so that the host transfers the network signal to a network controller of the host via an adapter.

This application claims priority to Taiwan Patent Application No. 101133876 filed on Sep. 14, 2012, which is hereby incorporated by reference in its entirety.

### CROSS-REFERENCES TO RELATED APPLICATIONS

Not applicable.

### BACKGROUND OF THE INVENTION

1. Field of the Invention

The present invention relates to an interface adapter and an interface adapting method thereof. More particularly, the interface adapter and the interface adapting method thereof of the present invention are used to transmit network data via a card slot.

2. Descriptions of the Related Art

Currently, many portable computers are made to have a thickness gradually closer to or even smaller than the dimension of the standard wired network RJ45 connector, so it becomes difficult to embed the RJ45 port into the portable computers. Unfortunately, portable computers that are lightweight and thin cannot access the wired network directly via network ports thereof.

To solve the aforesaid problem, there is a need to design an interface adapter and an interface adapting method, which can connect the wired network to portable computers and also match the dimensions of the existing portable computers to reduce the cost.

### SUMMARY OF THE INVENTION

The present invention provides an interface adapter and an interface adapting method thereof that are used to receive a network signal of a wired network and to transmit network data via an existing memory card slot of a portable computer.

To achieve the aforesaid objective, the present invention provides an interface adapter, which comprises a network interface and a card interface. The network interface is configured to connect with a wired network for receiving a network signal from the wired network. The card interface is electrically connected with the network interface, and is configured to connect with a card slot of a host and to transmit the network signal to the host via the card slot so that the host forwards the network signal to a network controller of the host via an adapter.

To achieve the aforesaid objective, the present invention further provides an interface adapting method, which comprises the following steps: connecting a network interface disposed on a body with a wired network; receiving a network signal from the wired network by the network interface; connecting a card interface, which is disposed on the body and electrically connected with the network interface, with a card slot of a host; transmitting the network signal to the host via the card slot by the card interface; and forwarding the network signal to a network controller of the host via an adapter by the host.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a schematic view of an interface adapter according to a first embodiment of the present invention;

FIG. 2 is a schematic view of an interface adapter according to a second embodiment of the present invention; and

FIG. 3 is a flowchart diagram of an interface adapting method according to a third embodiment of the present invention.

### DESCRIPTION OF THE PREFERRED EMBODIMENT

In the following descriptions, the present invention will be explained with reference to embodiments thereof. However, these embodiments are not intended to limit the present invention to any specific environments, applications or implementations described in these embodiments. Therefore, description of these embodiments is only for purpose of illustration rather than to limit the present invention. It shall be appreciated that, in the following embodiments and the attached drawings, elements not directly related to the present invention are omitted from depiction.

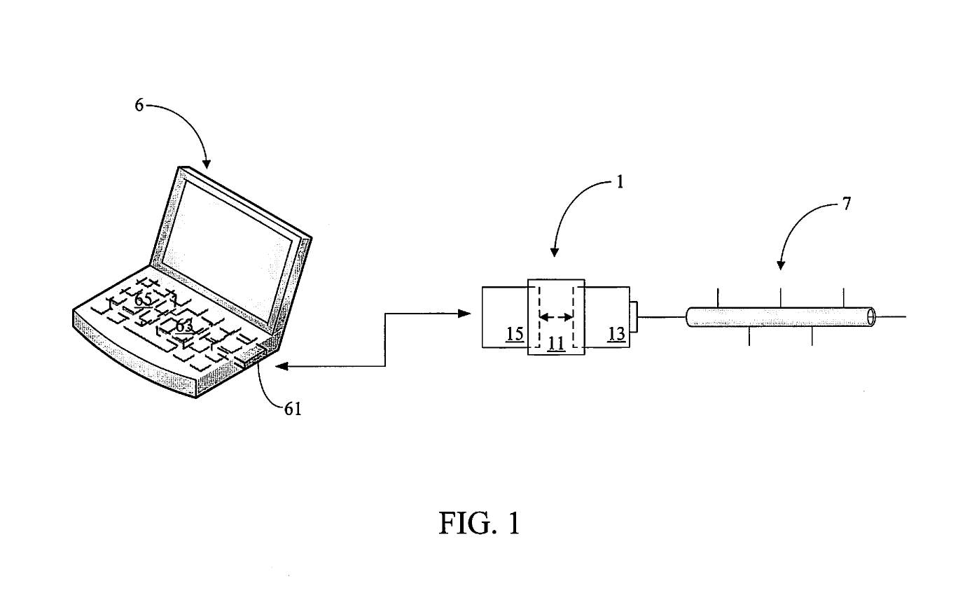

FIG. 1 illustrates a schematic view of an interface adapter 1 according to a first embodiment of the present invention. The interface adapter 1 comprises a body 11, a network interface 13 and a card interface 15. Both the network interface 13 and the card interface 15 are disposed on the body 11. The card interface 15 is electrically connected with the network interface 13, and thus, receives an electric signal from the network interface 13.

When a user needs to use a host 6 to access network resources, the user inserts the card interface 15 of the interface adapter 1 into a card slot 61 of the host 6. Furthermore, the network interface 13 is connected with a wired network 7 to receive a network signal from the wired network 7. Then, the interface adapter 1 transmits the network signal, which is received from the network interface 13, to the host 6 via the card interface 15. Then, the host 6 forwards the network signal to a network controller 65 via an adapter 63 connected to the card slot 61 so that the host 6 accesses the network resources according to the network signal.

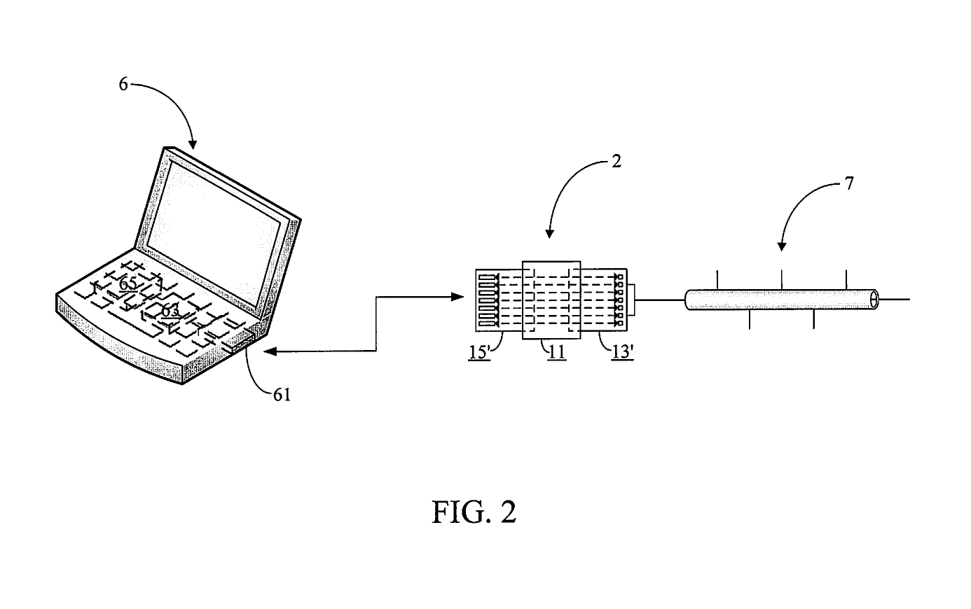

Referring to FIG. 2, there is shown a schematic view of an interface adapter 2 according to a second embodiment of the present invention. It shall be particularly appreciated that the hardware structure and the network connection environment of the second embodiment are similar to those of the first embodiment, so the components with the same reference numerals and the functions thereof will not be further described herein.

The second embodiment differs from the first embodiment in that in the second embodiment, a network interface 13′ of the interface adapter 2 further comprises a plurality of first pins 131, a card interface 15′ further comprises a plurality of second pins 151, the network interface 13′ electrically connects with the card interface 15′ via the first pins 131 and the second pins 151, the network interface 13′ transmits a network signal to the card interface 15′, and the card interface 15′ transmits the network signal to the host 6 via the second pins 151.

For example, the network interface may be an RJ-45 network connector having an extended line, which is connected to a network via a network device having an RJ-45 network port. Furthermore, the network interface may also be an RJ-45 network port; and in this case, a network line conforming to the RJ-45 specifications is connected to both the network interface and a network device having an RJ-45 network port so that the network interface is also connected with a network.

Furthermore, the card interface may conform to one of connecting specifications of Secure Digital Memory Card (SD Card), Memory Stick Card (MS Card) and Extreme Digital-Picture Card (xD Card). In addition, both the card and the slot thereof have a relatively low profile, so most of the portable computers currently available in the market that are designed to be lightweight and low-profile are still provided with a slot for such a card to allow the user to access the data.

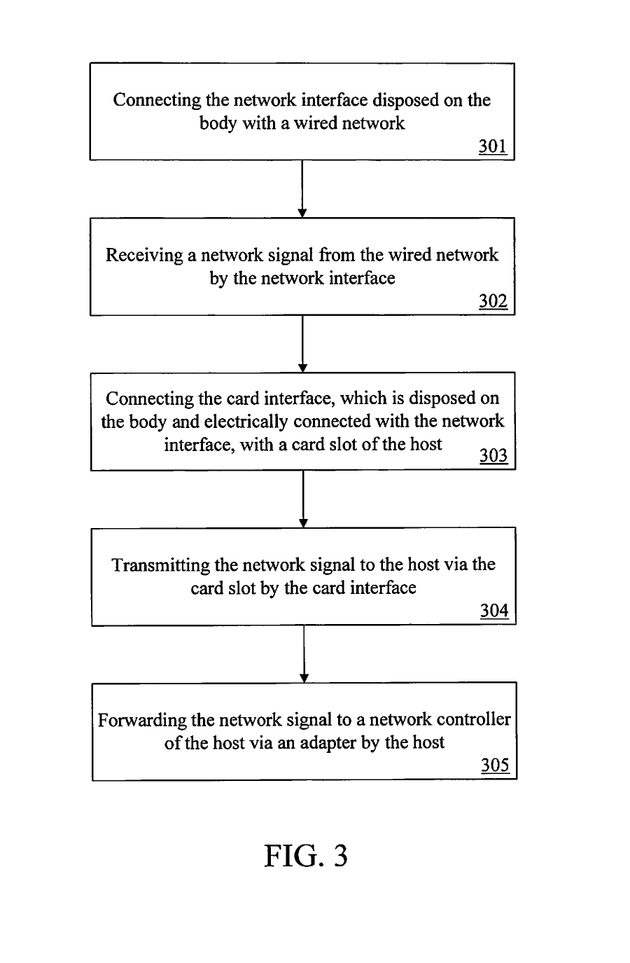

A third embodiment of the present invention is an interface adapting method, a flowchart diagram of which is shown in FIG. 3. The interface adapting method of the third embodiment is used in an interface adapter (e.g., the interface adapters 1, 2 of the aforesaid embodiments) and a host. The interface adapter comprises a body, and a network interface and a card interface that are disposed on the body. The network interface is electrically connected with the card interface. The detailed steps of the third embodiment are as follows.

Step 301 is executed to connect the network interface disposed on the body with a wired network. Then, step 302 is executed to enable the network interface to receive a network signal from the wired network. Step 303 is executed to connect the card interface, which is disposed on the body and electrically connected with the network interface, with a card slot of the host. Step 304 is executed to enable the card interface to transmit the network signal to the host via the card slot. Finally, step 305 is executed to enable the host to forward the network signal to a network controller of the host via an adapter.

Similarly, in other implementations, the network interface of the interface adapter of the third embodiment may further comprise a plurality of first pins, and the card interface may further comprise a plurality of second pins. The network interface electrically connects with the card interface via the first pins and the second pins. Then, the network interface transmits the network signal to the card interface, and the card interface transmits the network signal to the host via the second pins.

Additionally, the network interface of the third embodiment may be a network connector having an extended line, which is connected to a network via a network device having an RJ-45 network port. Furthermore, the network interface may also be an RJ-45 network port; and in this case, a network line conforming to the RJ-45 specifications is connected to both the network interface and a network device having an RJ-45 network port so that the network interface is also connected with a network.

Furthermore, the card interface of the third embodiment may also conform to one of connecting specifications of Secure Digital Memory Card (SD Card), Memory Stick Card (MS Card) and Extreme Digital-Picture Card (xD Card).

Accordingly, when the card slot of the portable computer forwards a network signal to a network control card via the adapter, the interface adapter of the present invention successfully transmits the network signal, which is received by the network interface, to the network control card of the portable computer via the card interface conforming to the aforesaid card specifications so that the portable computer can access the network resources.

According to the above descriptions and in consideration of the trend towards portable computers that have become increasingly more lightweight and low-profile, the interface adapter of the present invention directly uses the existing specifications and configurations of the portable computer to accomplish a connection with the wired network. Thus, the connection with the wired network is achieved while a low hardware cost is maintained.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended. What is claimed is:

1. An interface adapter, comprising:
a body;
a network interface, being disposed on the body, and being configured to connect with a wired network for receiving a network signal from the wired network; and
a card interface, being disposed on the body and electrically connected with the network interface, and being configured to connect with a card slot of a host and to transmit the network signal to the host via the card slot so that the host transfers the network signal to a network controller of the host via an adapter.

2. The interface adapter as claimed in claim 1, wherein the network interface comprises a plurality of first pins, the card interface comprises a plurality of second pins, the network interface electrically connects with the card interface via the first pins and the second pins, and the card interface transmits the network signal to the host via the second pins.

3. The interface adapter as claimed in claim 1, wherein the network interface is an RJ-45 connector.

4. The interface adapter as claimed in claim 1, wherein the network interface is an RJ-45 port.

5. The interface adapter as claimed in claim 1, wherein the card interface conforms to one of connecting standards of Secure Digital Memory Card (SD Card), Memory Stick Card (MS Card) and Extreme Digital-Picture Card (xD Card).

6. An interface adapting method, comprising:
connecting a network interface disposed on a body with a wired network;
receiving a network signal from the wired network by the network interface;
connecting a card interface, which is disposed on the body and electrically connected with the network interface, with a card slot of a host;
transmitting the network signal to the host via the card slot by the card interface; and
transferring the network signal to a network controller of the host via an adapter by the host.

7. The interface adapting method as claimed in claim 6, wherein the network interface comprises a plurality of first pins, the card interface comprises a plurality of second pins, the network interface connects with the card interface via the first pins and the second pins, and the card interface transmits the network signal to the host via the second pins.

8. The interface adapting method as claimed in claim 6, wherein the network interface is an RJ-45 connector.

9. The interface adapting method as claimed in claim 6, wherein the network interface is an RJ-45 port.

10. The interface adapting method as claimed in claim 6, wherein the card interface conforms to one of connecting standards of Secure Digital Memory Card (SD Card), Memory Stick Card (MS Card) and Extreme Digital-Picture Card (xD Card).
